(19) United States
(12) Patent Application Publication
(10) Pub. No.: US 2012/0170266 A1
(43) Pub. Date: Jul. 5, 2012

(54) EDGE-LIT MODULAR CEILING TILE LIGHT FIXTURES

(75) Inventors: Steve Germain, Quebec (CA); Sebastien Magnan, Quebec (CA); Samuel Grebe, East Cleveland, OH (US); Simon Fisher, Bedfordshire (GB)

(73) Assignee: GE Lighting Solutions, LLC

(21) Appl. No.: 13/334,395

(22) Filed: Dec. 22, 2011

Related U.S. Application Data
(60) Provisional application No. 61/429,632, filed on Jan. 4, 2011.

(51) Int. Cl. F21V 7/00; F21V 17/08

(52) U.S. Cl. 362/235; 29/428

(57) ABSTRACT

A ceiling tile light fixture includes a ceiling tile and a light fixture disposed within the ceiling tile. The light fixture includes one or more light sources and a waveguide for reflecting light from the one or more light sources. A power supply for supplying power to the one or more light sources.

This application claims the benefit of U.S. Provisional Application Ser. No. 61/429,632, filed Jan. 4, 2011, the disclosure of which is herein incorporated by reference.

### BACKGROUND

The present exemplary embodiments relate to the illumination arts, lighting arts, and related arts. It finds particular application in conjunction with modular ceiling tile light fixtures, and will be described with particular reference thereto. However, it is to be appreciated that the present exemplary embodiments are also amenable to other like applications.

Traditional ceiling tile light fixtures use conventional fluorescent lights and high voltage fluorescent lighting fixtures as the lighting system. Typically, the traditional ceiling tile light fixtures utilize conventional fluorescent lights to illuminate the whole ceiling tile. These configurations pose several problems. For example, the configuration does not provide a uniform distribution of light. Specifically, “black spots” are present near the edges of the ceiling tiles due to a lack of illumination provided at the ballast of the conventional fluorescent lights. Conventional fluorescent lights also do not produce a continuous steady output of light due to the fluctuation in the frequency of driving voltage. Some also find the conventional fluorescent light color harsh and displeasing. As LEDs become more popular and prevalent, it has become desirable to replace the conventional fluorescent lights with LED lighting units.

It has also become desirable in commercial settings to have ceiling lighting arrangements which can be designed for a specific need or style. Traditional ceiling tile light fixtures are not suited for providing designs which answer specific needs such as location layout, function, or style. Specifically, traditional ceiling tile light fixtures cannot be seamlessly connected to create a continuous lighting arrangement in defined lighting arrangements. The need exists for a ceiling tile lighting fixture that can be used to create multiple lighting layouts in an aesthetically pleasing manner.

The present exemplary embodiments provide a new and improved modular ceiling tile light fixture which overcomes the above-referenced problems and others.

### SUMMARY

Various details of the present disclosure are hereinafter summarized to provide a basic understanding. This summary is not an extensive overview of the disclosure and is intended neither to identify certain elements of the disclosure, nor to delineate the scope thereof. Rather, the primary purpose of the summary is to present certain concepts of the disclosure in a simplified form prior to the more detailed description that is presented hereinafter.

According to one aspect of the present disclosure, a ceiling tile light fixture is provided. The ceiling tile light fixture includes a ceiling tile and a light fixture disposed within the ceiling tile. The light fixture includes one or more light sources and a waveguide for reflecting light from the one or more light sources. A power supply for supplying power to the one or more light sources.

According to another aspect of the present disclosure, a ceiling tile light fixture system is provided. The ceiling tile light fixture system includes a plurality of ceiling tile light fixtures configured to form a continuous lighting arrangement between adjacent ceiling tiles.

According to another aspect of the present disclosure, a method for making a ceiling tile light fixture is provided. The method includes disposing a light fixture within the ceiling tile. The light fixture includes one or more light sources and a waveguide for reflecting light from the one or more light sources.

### BRIEF DESCRIPTION OF THE DRAWINGS

FIG. 1 is a bottom view of a modular ceiling tile light fixture in accordance with the present exemplary embodiment;

FIG. 2 is a perspective view of the modular ceiling tile light fixture depicted in FIG. 1;

FIGS. 3 and 4 are side views of the modular ceiling tile light fixture depicted in FIG. 1;

FIG. 5 is a bottom view of another alternative embodiment of a modular ceiling tile light fixture in accordance with the present exemplary embodiment;

FIG. 6 is a perspective view of the modular ceiling tile light fixture depicted in FIG. 5;

FIGS. 7 and 8 are side views of the modular ceiling tile light fixture depicted in FIG. 5;

FIG. 9 is a bottom view of another alternative embodiment of a modular ceiling tile light fixture in accordance with the present exemplary embodiment;

FIG. 10 is a perspective view of the modular ceiling tile light fixture depicted in FIG. 9;

FIGS. 11 and 12 are side views of the modular ceiling tile light fixture depicted in FIG. 9;

FIG. 13 is a bottom view of another alternative embodiment of a modular ceiling tile light fixture in accordance with the present exemplary embodiment;

FIG. 14 is a perspective view of the modular ceiling tile light fixture depicted in FIG. 13;

FIGS. 15 and 16 are side views of the modular ceiling tile light fixture depicted in FIG. 13;

FIG. 17 is bottom view of a modular ceiling tile light fixture system in accordance with the present exemplary embodiment.

### DETAILED DESCRIPTION

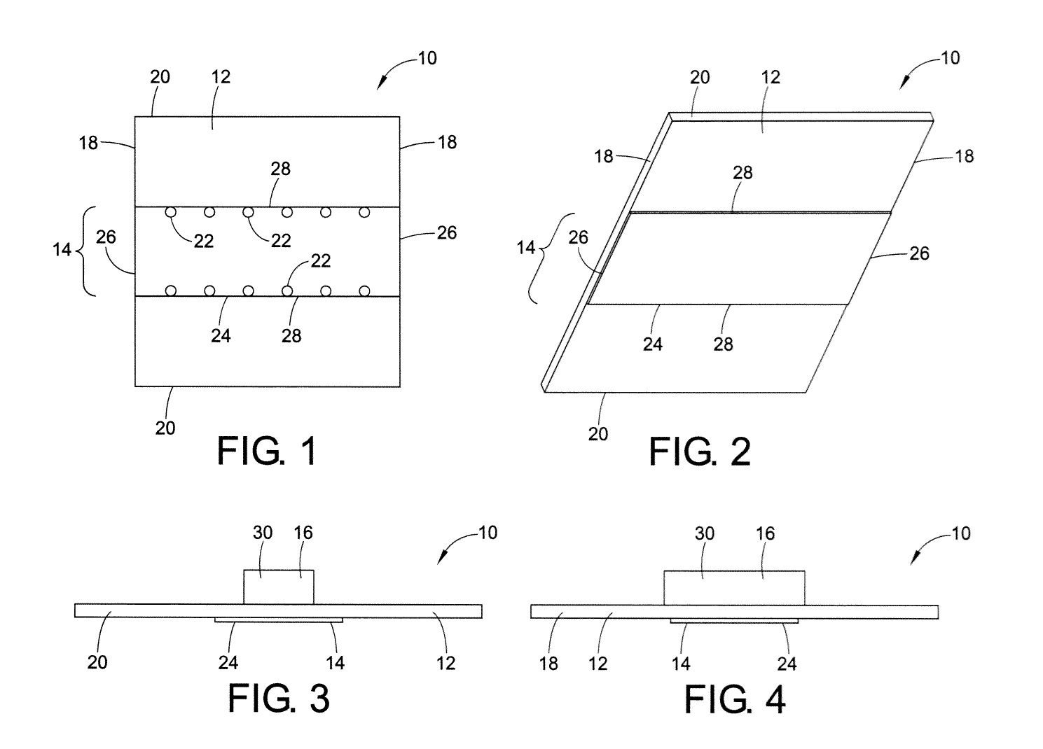

With reference to FIGS. 1-4, a modular ceiling tile light fixture 10 including a combination of a ceiling tile 12 and a light fixture 14 is shown. The ceiling tile light fixture 10 can be a traditional size and shape to allow it to fit into existing ceiling tile or drop-ceiling mounting hardware for applications such as office ceiling lighting, commercial ceiling lighting, industrial ceiling lighting, and the like. When fit in the ceiling tile construction, the light fixture 14 can illuminate the ceiling tile light fixture 10 to its edge of the ceiling tile 12 such that each adjacent modular ceiling tile light fixture 10 seamlessly connect to create a continuous lighting arrangement. The light fixture 14 also includes a power supply and control unit 16 to adjust the intensity of u inat on, the color of illumination, pattern of illumination, and the like.

The modular ceiling tile light fixture 10 can be constructed of light weight material used in the interior of buildings. Numerous conventional ceiling tiles can be used having various functional and decorative patterns. In one embodiment, the modular ceiling tile light fixture 10 has a generally planar rectangular shape. The ceiling tile 12 can be, for example, fabricated from perlite, wood, metal, mineral fiber, mineral wood, plastic, tin, aluminum, PVC, and the like. The modular ceiling tile light fixture 10 is designed to allow for the light fixture 14 to be disposed or attached to the ceiling tile 12. For example, the modular ceiling tile light fixture 10 includes an opening to allow the light fixture 14 to be oriented flush or recessed with respect to the surface of the ceiling tile 12. It is also appreciated that the modular ceiling tile light fixture 10 facilitates access to the above mounting hardware and can be easily changed, removed, or replaced as needed. The modular ceiling tile light fixture 10 is typically attached to ceiling tile mounting hardware such as steel grids, furring strips, tack and clip systems, high strength adhesives, and the like. The modular ceiling tile light fixture 10 is also designed for a seamless interlocking or jointed design with adjacent ceiling tiles and modular ceiling tile light fixtures. As illustrated, the modular ceiling tile light fixture 10 has a first pair of parallel fixture edges 18 and a second pair of fixture parallel edges 20, the first set of fixture edges 18 being perpendicular to the second set of fixture edges 20.

FIGS. 1 and 2 are bottom views of the modular ceiling tile light fixture 10 illustrating the combination of the ceiling tile 12 and the light fixture 14. The light fixture 14 includes one or more light sources 22 and a waveguide 24 to provide a defined light pattern toward an outward facing surface of the ceiling tile 12. The waveguide 24 is any structure which permits the propagation of light throughout its structure despite diffractive effects and structure of the waveguide. The waveguide 24 is defined by an extended region of increased index of refraction relative to the surrounding medium. The strength of the guiding, or the confinement, of the light depends on the wavelength, the index difference and the guide width of the waveguide. The waveguide can be, for example, fabricated from glass, plastic, polymers, and the like. Numerous conventional waveguides can be used having various functional and decorative light patterns. The waveguide 24 can provide a continuous uniform distribution of light emitted from the one or more light sources 22 along the entire waveguide 24.

As illustrated in FIGS. 1 and 2, the waveguide 24 is generally straight shaped extending the length of the modular ceiling tile light fixture 10 and includes first and second sets of parallel waveguide edges, the first set of waveguide edges 26 positioned through the fixture edges 18, 20 of the modular ceiling tile light fixture 10 and the second set of waveguide edges 28 positioned perpendicular to the first set of waveguide edges 26 and spaced apart from the fixture edges 18, 20 of the modular ceiling tile light fixture 10. For example, the first set of waveguide edges 26 extend through the fixture edges 18, 20 of the modular ceiling tile light fixture 10 to provide a uniform distribution of light to the fixture edges 18, 20 whereas the second set of waveguide edges 28 are positioned within the fixture edges 18, 20 of the modular ceiling tile light fixture 10. It is also contemplated that the waveguide 24 could extend to all the fixture edges 18, 20 of the modular ceiling tile light fixture 10.

The waveguide 24 is disposed outwardly from an outward facing side of the modular ceiling tile light fixture 10. The positioning of the waveguide 24 provides illumination from the one or more light sources 22 as interior light. The waveguide 24 includes a reflective surface that can include one or more defects on the surface to create a desired intensity and illumination pattern. The one or more light sources 22 are disposed between the reflective surface and the waveguide edges 26, 28. The waveguide 24 receives and transports light rays from the one or more light sources 22 such that only the reflective light from the waveguide 24 is provided as interior light. For example, the waveguide 24 is designed such that the one or more light sources 22 are not visible from outside the modular ceiling tile light fixture 10 and the only light provided is reflected from the waveguide 24. The color of the waveguide can be opaque, clear, any color matching the color of the ceiling tile, and the like. For example, the color of the waveguide 24 can be clear or match the color of the ceiling tile such that when the light sources are not providing light and waveguide appears to be part of the ceiling tile and is not visible to onlookers.

The one or more light sources 22 are positioned along the second set of waveguide edges 28 to provide light continuously along the length of the waveguide 24. The one or more light sources 22 typically include light emitting diodes (LEDs) but it is also contemplated that the light sources can include fluorescent lights and the like. The brightness and/or performance of the modular ceiling tile light fixture 10 can be adjusted by adding, subtracting and/or replacing the number of light sources 22. As illustrated in FIG. 1, six light sources 22 are mounted on each second edge 28 of the waveguide 24. It is contemplated that the light fixture 14 can include many small LEDs (e.g. 0.1 to 0.5 watt LEDs) or fewer larger LEDs (e.g. 1 watt LEDs). As shown in FIG. 1, the distance between the light sources 22 is uniform but it is contemplated that the distance between the light sources 22 can also be non-uniform. It is contemplated that more or less light sources 22 can be included based on the desired brightness and/or performance of the modular ceiling tile light fixture 10. Preferably, the light emitted from the one or more light source is white but it is also contemplated that the light sources 22 can emit different color light.

FIGS. 2 and 4 are side views of the modular ceiling tile light fixture 10 illustrating the combination of the ceiling tile 12 and the light fixture 14 along with the power supply and control unit 16. The power supply and control unit 16 includes electric power conditioning and regulating electronics and circuits, transformers, power supplies, and the like to convert the standard line voltages to the appropriate voltage to operate the light sources 22. For example, a power regulating circuit can regulate the flow of current to allow the light fixture 14 to dynamically adapt to an increased load such as an additional light source. A power conditioning circuit may convert alternating current voltage to a direct current voltage. For example, the power conditioning circuit may convert 120 or 240 volt alternating current voltage to a direct current voltage. The power conditioning circuit may additionally, or alternatively, correct for polarity of the incoming power so that the power supply wires that connect to the light fixture 14 can be connected without having to worry about which wire connects to which element of the power conditioning circuit. As shown in FIGS. 2 and 4, the modular ceiling tile light fixture 10 further includes an enclosure 30 for locating or storing the various electronics and circuits needed to operate the light fixture 14.

The power supply and control unit 16 also includes a controller to control the illumination and intensity of the light sources 22. For example, the controller of the power supply and control unit 16 can provide a dimming function to light sources 22. The controller of the power supply and control unit 16 can also control the light sources 22 to emit any desired color light. As stated above, the light sources 22 may include blue light sources, green light sources, red light source, different color temperature white light sources, varying combinations of one or more of blue, green, red and white light sources, and the like. The controller of the power supply and control unit 16 can control the waveguide 24 to shape the light output in a desired shape, such as circle, ellipse, trapezoid or other pattern. For example, the controller of the power supply and control unit 16 can control the intensity, color, and desired shape of the light provided by the light source 22 such that the modular ceiling tile light fixture 10 can output different colored light patterns as desired.

The controller of the power supply and control unit 16 includes at least one processor, for example a microprocessor, a microcontroller, a digital signal processor (DSP), a general purpose processor, an application specific integrated circuit (ASIC), a dedicated processor, or other software controlled device configured to execute software for performing the operations described in further detail below. Typically, the software is carried on tangible memory or a computer readable medium for execution by the processor. Non-transitory computer readable media can include memory such as a hard disk drive, CD-ROM, DVD-ROM, internet servers, and the like. Other types of the processor are also contemplated. Display controllers, Application Specific Integrated Circuits (ASICs), FPGAs, and microcontrollers are illustrative examples of other types of components which may be used to provide the processor function. Embodiments may be implemented using software for execution by a processor, hardware, or some combination thereof.

The power supply and control unit 16 may be secured to a surface of the modular ceiling tile light fixture 10 with suitable fasteners such as screws or mounts, so as to be easily removable and dissipate heat generated by the light sources 22. For example, the mounting structure of the power supply and control unit 16, the light fixture 14, and the modular ceiling tile light fixture 10 can act as a heat sink to dissipate any heat generated by the light sources 22. It is also contemplated that the power supply and control unit 16 is removable and can provide power and control to multiple adjacent modular ceiling tile light fixtures 10. For example, a central power supply and control unit can be provided to supply power and control to adjacent modular ceiling tile light fixtures 10 allowing the power supply and control unit of the adjacent edge modular ceiling tile light fixtures 10 to be removed.

The modular ceiling tile light fixture 10 provides interior light based on the principle of edge lighting. Each modular ceiling tile light fixture 10 is illuminated by coupling the light of the corresponding light sources 22 into the waveguide 24 through its fixture edge 18, 20. Adjacent modular ceiling tile light fixtures 10 can be seamlessly connected to create a continuous light arrangement by mounting ceiling tile in a defined design.

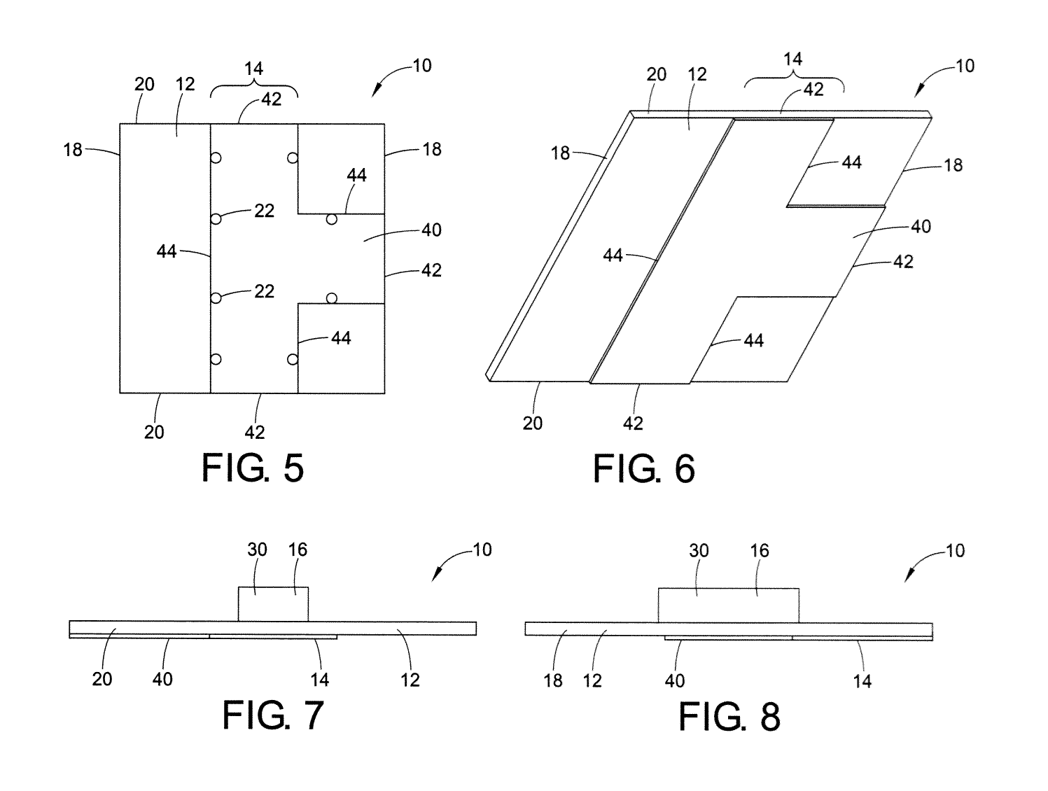

FIGS. 5-8 depicts an alternative embodiment of the modular ceiling tile light fixture 10. The components that are shown in FIGS. 5-8 are similar to the components that are shown in FIGS. 1-4 in that the modular ceiling tile light fixture 10 includes a ceiling tile 12, a light fixture 14 having a waveguide 40 and one or more light sources 22, and a power supply and control unit 16. The light fixture 14 includes one or more light sources 22 and a waveguide 40 to provide a defined light pattern as the interior light toward an outward facing surface of the modular ceiling tile light fixture 10. As illustrated in FIGS. 5 and 6, the waveguide 40 is generally “T” shaped extending the length and width of the modular ceiling tile light fixture 10 and includes two sets of edges positions within the modular ceiling tile light fixture 10. The first set of waveguide edges 42 positioned through the fixture edges 18, 20 of the modular ceiling tile light fixture 10 and the second set of waveguide edges 44 spaced apart from the fixture edges 18, 20 of the modular ceiling tile light fixture 10. For example, the first set of waveguide edges 42 extend through the fixture edges 18, 20 of the modular ceiling tile light fixture 10 to provide a uniform distribution of light to the fixture edges 18, 20 whereas the second set of waveguide edges 44 are positioned within the fixture edges 18, 20 of the modular ceiling tile light fixture 10. The one or more light sources 22 are positioned along the second set of waveguide edges 44 to provide light continuously along the length of the waveguide 40. The power supply and control unit 16 includes electric power conditioning and regulating electronics and circuits, transformers, power supplies, and the like to convert the standard line voltages to the appropriate voltage to the light sources and for controlling the illumination, intensity, color, and pattern of the light emitted from the light sources.

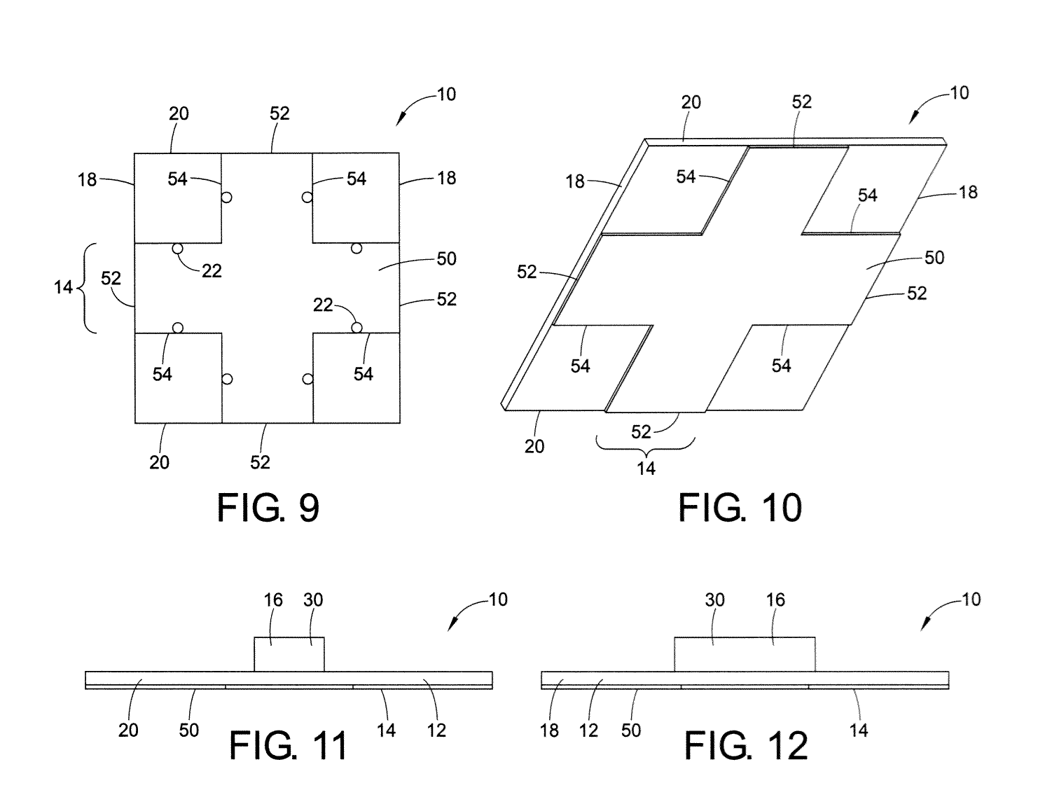

FIGS. 9-12 depicts an alternative embodiment of the modular ceiling tile light fixture 10. The components that are shown in FIG. 9-12 are similar to the components that are shown in FIG. 1-4 in that the modular ceiling tile light fixture 10 includes a ceiling tile 12, a light fixture 14 having a waveguide 50 and one or more light sources 22, and a power supply and control unit 16. The light fixture 14 includes one or more light sources 22 and a waveguide 50 to provide a defined light pattern as the interior light toward an outward facing surface of the modular ceiling tile light fixture 10. As illustrated in FIGS. 9 and 10, the waveguide 50 is a generally cross shaped extending the length and width of the modular ceiling tile light fixture 10 and includes two sets of edges positions within the modular ceiling tile light fixture 10. The first set of waveguide edges 52 positioned through the fixture edges 18, 20 of the modular ceiling tile light fixture 10 and the second set of waveguide edges 54 spaced apart from the fixture edges 18, 20 of the modular ceiling tile light fixture 10. For example, the first set of waveguide edges 52 extend through the fixture edges 18, 20 of the modular ceiling tile light fixture 10 to provide a uniform distribution of light to the fixture edges 18, 20 whereas the second set of waveguide edges 54 are positioned within the fixture edges 18, 20 of the modular ceiling tile light fixture 10. The one or more light sources 22 are positioned along the second set of waveguide edges 54 to provide light continuously along the length of the waveguide 50. The power supply and control unit 16 includes electric power conditioning and regulating electronics and circuits, transformers, power supplies, and the like to convert the standard line voltages to the appropriate voltage to the light sources and for controlling the illumination, intensity, color, and pattern of the light emitted from the light sources.

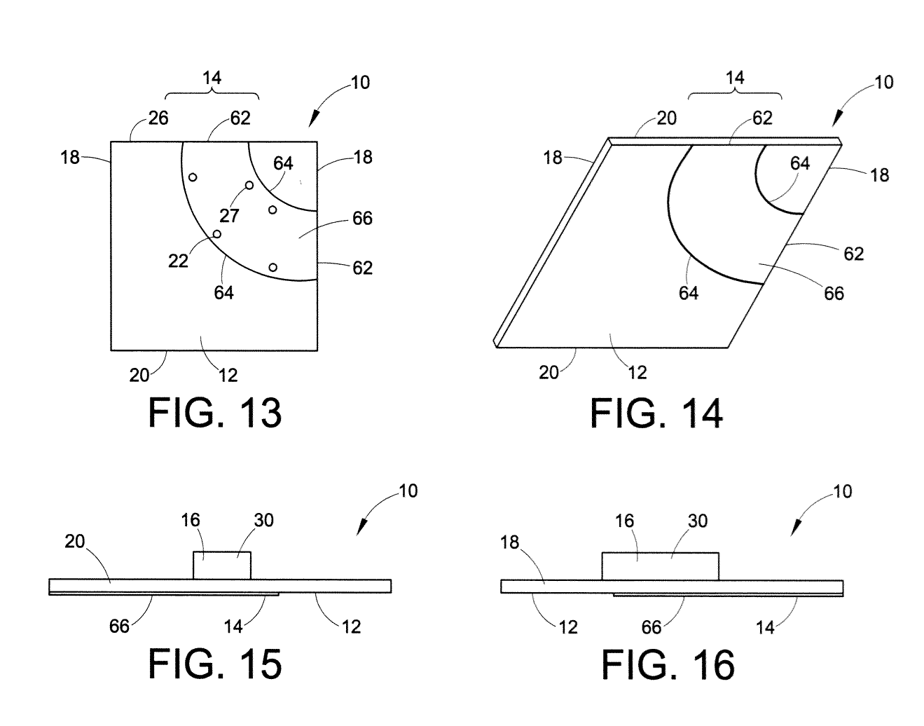

FIGS. 13-16 depicts an alternative embodiment of the modular ceiling tile light fixture 10. The components that are shown in FIG. 13-16 are similar to the components that are shown in FIG. 1-4 in that the modular ceiling tile light fixture 10 includes a ceiling tile 12, a light fixture 14 having a waveguide 60 and one or more light sources 22, and a power supply and control unit 16. The light fixture 14 includes one or more light sources 22 and a waveguide 60 to provide a defined light pattern as the interior light toward an outward facing surface of the modular ceiling tile light fixture 10. As illustrated in FIGS. 13 and 14, the waveguide 60 is a generally 90 degree turn within of the modular ceiling tile light fixture 10 and includes two sets of edges positions within the modular ceiling tile light fixture 10. The first set of waveguide edges 62 positioned through the fixture edges 18, 20 of the modular ceiling tile light fixture 10 and the second set of waveguide edges 64 spaced apart from the fixture edges 18, 20 of the modular ceiling tile light fixture 10. For example, the first set of waveguide edges 62 extend through the fixture edges 18, 20 of the modular ceiling tile light fixture 10 to provide a uniform distribution of light to the fixture edges 18, 20 whereas the second set of waveguide edges 64 are positioned within the fixture edges 18, 20 of the modular ceiling tile light fixture 10. The one or more light sources 22 are positioned along the second set of waveguide edges 64 to provide light continuously along the length of the waveguide 60. The power supply and control unit 16 includes electric power conditioning and regulating electronics and circuits, transformers, power supplies, and the like to convert the standard line voltages to the appropriate voltage to the light sources and for controlling the illumination, intensity, color, and pattern of the light emitted from the light sources.

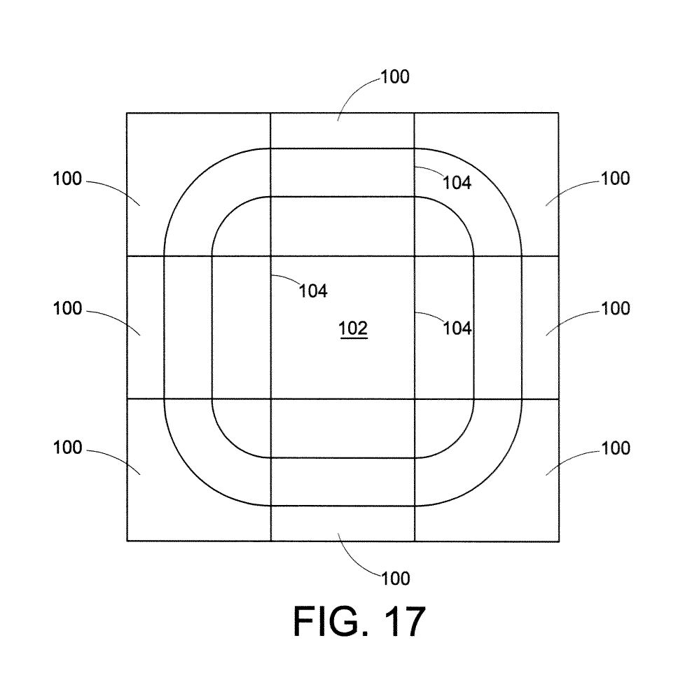

FIG. 17 depicts modular ceiling tile light fixture system. The system includes multiple modular ceiling tile light fixtures 100 and standard ceiling tiles 102. As illustrated the multiple modular ceiling tile light fixture 100 form a seamless continuous “racetrack” light arrangement. It is also contemplated that other unique lighting arrangements and configurations can be utilized based on specific needs such as location layout, function, or style. The modular ceiling tile light fixtures 100 and standard ceiling tiles 102 are mounted with a seamless interlocking or jointed design. For example, the modular ceiling tile light fixtures 100 and standard ceiling tiles 102 are mounted such that they appear to be part of a single lighting arrangement or configuration. The interlocking 104 between the modular ceiling tile light fixtures 100 and standard ceiling tiles 102 include mechanical mounts to secure the tiles to the ceiling mounting hardware as well as to adjacent tiles. The interlocking 104 also include electrical connectors so that a power supply and control unit and supply power and control adjacent modular ceiling tile light fixtures 100.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A ceiling tile light fixture comprising:
a ceiling tile;
a light fixture disposed within the ceiling tile, the light fixture comprising:
one or more light sources; and
a waveguide for reflecting light from the one or more light sources; and
a power supply for supplying power to the one or more light sources.

2. The fixture according to claim 1, wherein the waveguide is configured to provide a uniform distribution of light from the one or more light sources along the entire waveguide.

3. The fixture according to claim 1, wherein a shape of the waveguide us selected from one of a straight line, a 90 degree turn, a “T”, and a cross.

4. The fixture according to claim 1, wherein the waveguide provides a uniform distribution of light from the one or more light sources to the at least two edges of the ceiling tile light fixture.

5. The fixture according to claim 1, wherein the one or more light sources comprise light emitting diodes.

6. The fixture according to claim number 1, wherein the one or more light sources illuminate the waveguide by directing light into an edge of the waveguide.

7. The fixture according to claim 1, further comprising:
a controller for controlling at least one of the intensity, color, and desired shape of the light provided by the one or more light sources.

8. The fixture according to claim 1, wherein the power supply is configured to supply power to at least one adjacent ceiling tile light fixture.

9. The fixture according to claim 1, wherein the waveguide is made of at least one of glass, plastic, and a polymer.

10. The fixture according to claim 1, wherein the ceiling tile is made from at least one of perlite, wood, plastic, metal, and mineral fiber.

11. The fixture of claim 1, wherein the waveguide is dispose in a channel in the ceiling tile.

12. A ceiling tile light fixture system comprising:
a plurality of ceiling tile light fixtures, wherein the ceiling tiles light fixtures are configured to form a continuous lighting arrangement between adjacent ceiling tiles

13. The system according to claim 12, wherein the ceiling light fixtures include a waveguide for directing light from one or more light sources into an edge of the waveguide.

14. The system according to claim 13, wherein the waveguide is dispose in a channel in the ceiling tile.

15. The system according to claim 13, wherein a shape of the waveguide us selected from one of a straight line, a 90 degree turn, a “T”, and a cross.

16. The system according to claim 13, wherein the waveguide provides a uniform distribution of light from the one or more light sources to the at least two edges of the ceiling tile light fixture.

17. A method for making a ceiling tile light fixture, the method comprising:
disposing a light fixture within the ceiling tile, wherein the light fixture comprises one or more light sources and a waveguide for reflecting light from the one or more light sources.

18. The method according to claim 17, wherein the waveguide is configured to direct light from one or more light sources into an edge of the waveguide.

19. The method according to claim 17, wherein the waveguide is configured to provide a uniform distribution of light from the one or more light sources to the at least two edges of the ceiling tile light fixture.

20. The method according to claim 17, wherein the ceiling tiles light fixtures are configured to form a continuous lighting arrangement between adjacent ceiling tiles.
